(19) United States
(12) Patent Application Publication
(10) Pub. No.: US 2016/0112932 A1
(43) Pub. Date: Apr. 21, 2016

(54) METHODS AND DEVICES FOR DISPLAYING WIRELESS DEVICE LIST

(71) Applicant: Xiaomi Inc., Beijing (CN)

(72) Inventors: Yuzhen WAN, Beijing (CN); Mingyang Yu, Beijing (CN); Shujie Wang, Beijing (CN)

(73) Assignee: Xiaomi Inc.

(21) Appl. No.: 14/695,204

(22) Filed: Apr. 24, 2015

Related U.S. Application Data
(63) Continuation of application No. PCT/CN2015/071275, filed on Jan. 22, 2015.

(30) Foreign Application Priority Data
Oct. 20, 2014 (CN) 201410559790.7

(51) Int. Cl. H04W 48/10; H04W 8/24; H04W 4/00; H04W 8/00

(52) U.S. Cl. CPC H04W 48/10; H04W 8/005; H04W 8/24; H04W 4/008; H04W 88/06

(57) ABSTRACT

A method for displaying a wireless device list, includes: acquiring broadcast information sent from a wireless device, the broadcast information including a first field for indicating a name of the wireless device and a second field for indicating a manufacturer of the wireless device; acquiring an identity of the manufacturer of the wireless device according to the second field; and displaying the name of the wireless device and the identity of the manufacturer in a wireless device list.

### CROSS-REFERENCE TO RELATED APPLICATIONS

This application is a continuation of International Application No. PCT/CN2015/071275, filed Jan. 22, 2015, which is based upon and claims priority to Chinese Patent Application No. 201410559790.7, filed Oct. 20, 2014, the entire contents of all of which are incorporated herein by reference.

### TECHNICAL FIELD

The present disclosure generally relates to a smart terminal technology and, more particularly, to methods and devices for displaying a wireless device list.

### BACKGROUND

A smart terminal, for example, a smartphone, may acquire information of surrounding wireless devices, such as surrounding WiFi access points or Bluetooth devices, such that the smartphone can access a network or send information through one of the wireless devices. Conventionally, when the smartphone acquires the information of the wireless devices, a wireless device list is displayed on the smartphone. A user can select a wireless device in the wireless device list for the smartphone to access the network.

### SUMMARY

According to a first aspect of the present disclosure, there is provided a method for displaying a wireless device list, comprising: acquiring broadcast information sent from a wireless device, the broadcast information including a first field for indicating a name of the wireless device and a second field for indicating a manufacturer of the wireless device; acquiring an identity of the manufacturer of the wireless device according to the second field; and displaying the name of the wireless device and the identity of the manufacturer in a wireless device list.

According to a second aspect of the present disclosure, there is provided a method for a wireless device to send broadcast information, comprising: generating a second field for indicating a manufacturer of the wireless device; and adding the second field into broadcast information and sending the broadcast information, the sent broadcast information including first field for indicating a name of the wireless device and the second field.

According to a third aspect of the present disclosure, there is provided a terminal, comprising: a processor; and a memory for storing instructions executable by the processor; wherein the processor is configured to: acquire broadcast information sent by a wireless device, the broadcast information including a first field for indicating a name of the wireless device and a second field for indicating a manufacturer of the wireless device; acquire an identity of the manufacturer of the wireless device according to the second field; and display the name of the wireless device and the identity of the manufacturer in a wireless device list.

According to a fourth aspect of the present disclosure, there is provided a wireless device, comprising: a processor; and a memory for storing instructions executable by the processor; wherein the processor is configured to: generate a second field for indicating a manufacturer of the wireless device; and add the second field into broadcast information and send the broadcast information, the sent broadcast information including a first field for indicating a name of the wireless device and the second field.

It is to be understood that both the foregoing general description and the following detailed description are exemplary and explanatory only and are not restrictive of the invention.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 illustrates an application scenario of a method for displaying a wireless device list, according to an exemplary embodiment.

FIG. 2 illustrates an application scenario of a method for displaying a wireless device list, according to an exemplary embodiment.

FIG. 3 is a flow chart of a method for displaying a wireless device list, according to an exemplary embodiment.

FIG. 4 is a flow chart of a method for a wireless device to send broadcast information, according to an exemplary embodiment.

FIG. 5 is a schematic diagram of an interface displaying a wireless device list, according to an exemplary embodiment.

FIG. 6 is a schematic diagram of an interface for prompting a user, according to an exemplary embodiment.

FIG. 7 is a block diagram of a terminal for displaying a wireless device, according to an exemplary embodiment.

FIG. 8 is a block diagram of a wireless device, according to an exemplary embodiment.

FIG. 9 is a block diagram of a terminal, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of devices and methods consistent with some aspects related to the invention as recited in the appended claims.

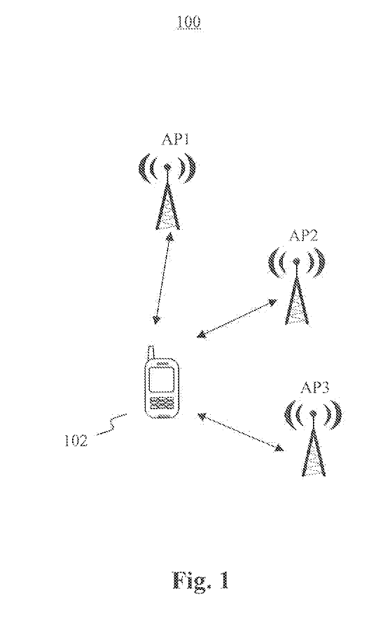

FIG. 1 illustrates an application scenario 100 of methods described below for displaying a wireless device list, according to an exemplary embodiment. In the scenario 100, a terminal, such as a mobile phone 102 used by a user, may acquire available wireless signals around. For example, assuming that first, second, and third wireless devices, e.g., access points AP1, AP2, and AP3, send broadcast information for accessing their respective wireless networks, the mobile phone 102 may acquire the broadcast information sent by the wireless devices AP1, AP2, and AP3, and display a wireless device list listing the wireless devices AP1, AP2, and AP3, according to the broadcast information. Related information regarding the wireless devices AP1, AP2 and AP3 is displayed on the mobile phone 102 using methods described below for displaying the wireless device list.

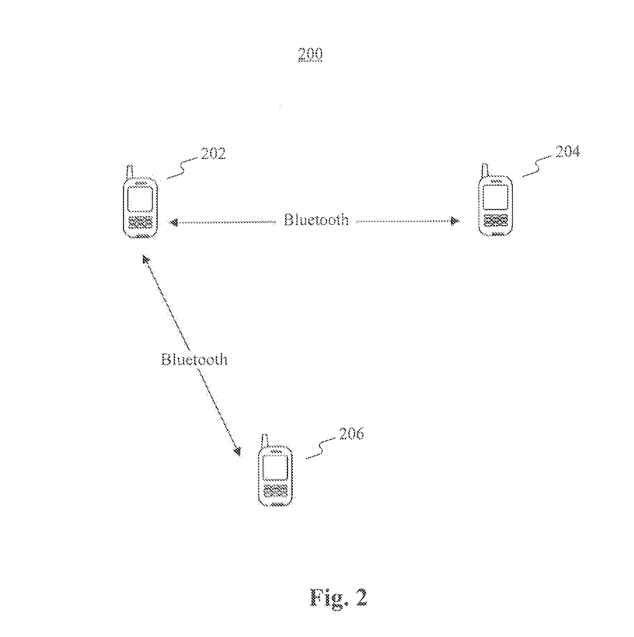

FIG. 2 illustrates an application scenario 200 of methods described below for displaying a wireless device list, according to an exemplary embodiment. In the scenario 200, a user uses a terminal, such as a mobile phone 202, to communicate with other mobile phones 204 and 206 of the user's friends through a Bluetooth manner. For example, the mobile phone 202 acquires some photos from the mobile phones 204 and 206 through the Bluetooth manner. To facilitate communication, the mobile phone 202 acquires surrounding Bluetooth signals, and displays information regarding the mobile phones 204 and 206 on the mobile phone 202, using methods described below for displaying a wireless device list, e.g., a Bluetooth device list.

In the above embodiments, the AP1, AP2, and AP3 (FIG. 1) and the mobile phones 204 and 206 with the Bluetooth capability (FIG. 2) are wireless devices configured to communicate with the terminal, and the terminal can display a wireless device list using methods described below to facilitate communication between the terminal and a wireless device selected by a user from the wireless device list. However, the present disclosure is not limited to the foregoing scenarios 100 (FIG. 1) and 200 (FIG. 2), and can be applied to other scenarios. Moreover, the terminal may be a mobile phone or any other device having a wireless communication capability.

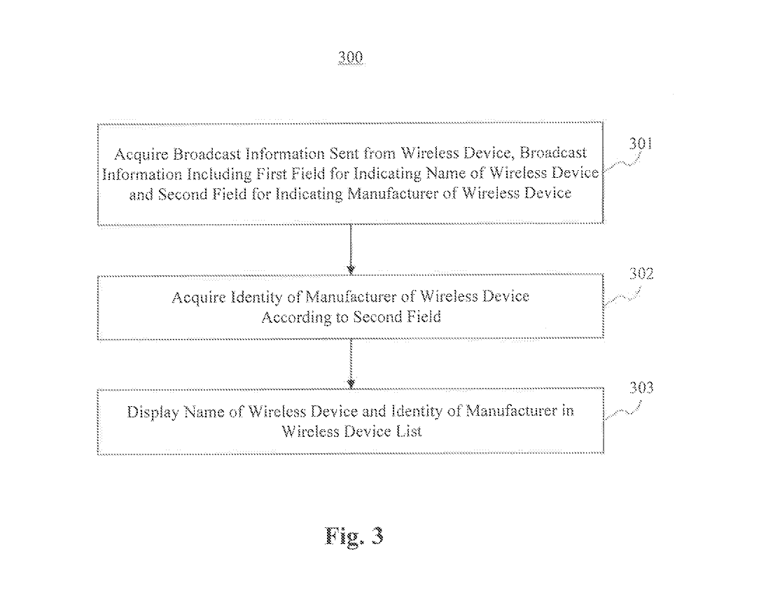

FIG. 3 is a flow chart of a method 300 for a terminal to display a wireless device list, according to an exemplary embodiment. For example, the terminal may be a mobile phone. Referring to FIG. 3, the method 300 includes the following steps.

In step 301, the mobile phone acquires broadcast information sent by a wireless device, the broadcast information including a first field for indicating a name of the wireless device and a second field for indicating a manufacturer of the wireless device. For example, the wireless device may be an access point, a Bluetooth device, etc.

In step 302, the mobile phone acquires an identity of the manufacturer of the wireless device according to the second field of the broadcast information.

In step 303, the mobile phone displays the name of the wireless device and the identity of the manufacturer in a wireless device list.

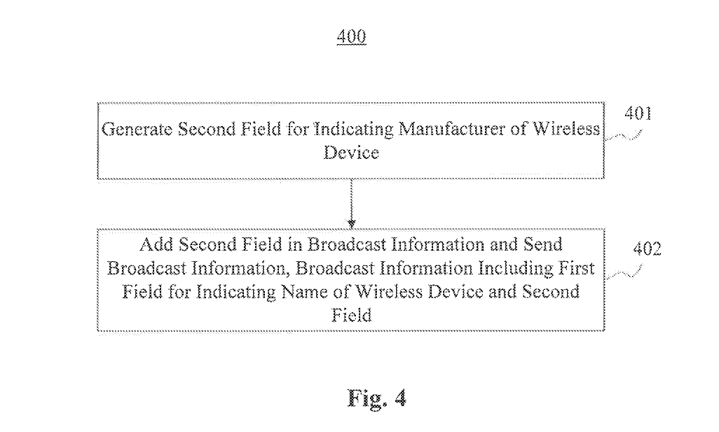

FIG. 4 is a flowchart of a method 400 for a wireless device to generate broadcasting information, according to an exemplary embodiment. For example, the wireless device may be an access point, a Bluetooth device, etc. Referring to FIG. 4, the method 400 includes the following steps.

In step 401, the wireless device generates a second field for indicating a manufacturer of the wireless device.

In step 402, the wireless device adds the second field in broadcast information and sends the broadcast information, the sent broadcast information including a first field for indicating a name of the wireless device and the second field for indicating the manufacturer of the wireless device.

Accordingly, when a mobile phone acquires the broadcast information, the mobile phone can acquire field information in the second field for indicating the manufacturer of the wireless, thereby to acquire an identity of the manufacturer of the wireless device. The mobile phone further displays the identity of the manufacturer of the wireless device in a wireless device list.

In one exemplary embodiment, the wireless device is a router. Accordingly, the second field is generated according to a manufacturer of the router, and is configured to indicate an identity of the manufacturer of the router. For example, if the router is a Xiaomi router, the second field is generated according to the manufacturer Xiaomi. Also for example, the second field is a wps_device_name field, and field information is set to Xiaomi_Router. In other words, Xiaomi_Router is filled in the wps_device_name field. Further for example, when the Xiaomi router sends a beacon signal including broadcast information, the broadcast information includes the first field for indicating a name of the router, e.g., defined by a user, and the second field for indicating Xiaomi as the manufacturer of the router.

After the mobile phone acquires the broadcast information sent by the router and including the first and second fields, the mobile phone acquires the identity of the manufacturer of the router according to the second field, and displays the name of the router and the identity of the manufacturer of the router in a wireless device list. In the foregoing example of the Xiaomi router, the field information in the second field included in the broadcast information sent by the router is Xiaomi_Router, and the mobile phone determines the corresponding identity of the manufacturer to be displayed according to Xiaomi_Router. The identity of the manufacturer may be displayed in various manners. For example, the identity of the manufacturer may be displayed as a text identity of the manufacturer or an icon identity of the manufacturer.

In one exemplary embodiment, the identity of the manufacturer is displayed by text. For example, the field information in the second field is Xiaomi_Router, and Xiaomi_Router may be directly displayed in the wireless device list. Also for example, the displayed text may be “Xiaomi_router.”

In one exemplary embodiment, the identity of the manufacturer is displayed by icon. For example, information in the second field is Xiaomi_Router, and a Xiaomi icon or logo may be displayed in the wireless device list.

In one exemplary embodiment, the mobile phone determines the manner to display the identity of the manufacturer based on a corresponding relationship between field information in the second field and an identity of each of one or more manufacturers. For example, the corresponding relationship may be stored in the mobile phone in advance. When the second field in the broadcast information sent by the wireless device is acquired, the mobile phone looks up the corresponding relationship to obtain an identity of the manufacturer corresponding to the information in the second field in the broadcast information, for example, as shown in the following Table 1.

TABLE 1

| Information in Second Field | Identity of Manufacturer |
|---|---|
| Xiaomi_Router | Xiaomi_Router |
| Xiaomi_Router | Xiaomi router |
| Xiaomi_Router | Xiaomi LOGO |

In one exemplary embodiment, for example, when the identity of the manufacturer is directly displayed according to the field information in the second field in the broadcast information, the field information may be customized by the manufacturer of the router. In the above example, the field information in the second field in the broadcast information customized by Xiaomi router is Xiaomi_Router. Other manufacturers may customize field information in the second field in broadcast information sent by their manufactured wireless devices. In addition, a user of a wireless device to provide a wireless network, such as a shopping mall or a store, may also request a manufacturer of the wireless device to customize device identity information sent by the wireless device to be, e.g., “XX shopping mall” or “XX store.”

In one exemplary embodiment, the mobile phone uses a WiFi module to display the identity of the manufacturer according to the acquired second field in the broadcast information. For example, a WiFi module according to an Android operating system may include four parts: settings, framework, supplicant and kernel. Also for example, the kernel part can acquire such information as a signal intensity and an encryption mode of a wireless device by scanning, and the supplicant part can read WiFi data scanned by the kernel part and transmit the WiFi data to the settings part in an upper layer for displaying.

In one exemplary embodiment, the WiFi data read by the supplicant part has the following format:

/**

| * Format of results: | |
|---|---|
| * ================= | |
| * id=1 | |
| * bssid=68:7f:74:d7:1b:6e | |
| * freq=2412 | |
| * level=−43 | |
| * tsf=1344621975160944 | |
| * age=2623 | |
| * flags=[WPA2-PSK-CCMP][WPS][ESS] | |
| * ssid=zubyb | |
| * ==== | */ |

The format includes: bssid (mac address of router), freq (frequency band of router), level (signal intensity), flags (encryption mode) and Ssid (router name). This information is acquired by the kernel part and transmitted by a wireless router. The broadcast information sent by the wireless router may include at least one of the above bssid, freq and the like. In the illustrated embodiment, a field wps_device_name is added in the supplicant part, for example wps_device_name=Xiaomi_Router. In this way, the supplicant part acquires Xiaomi_Router, and may transmit that information to the upper layer, e.g., the settings part, to display through the field wps_device_name.

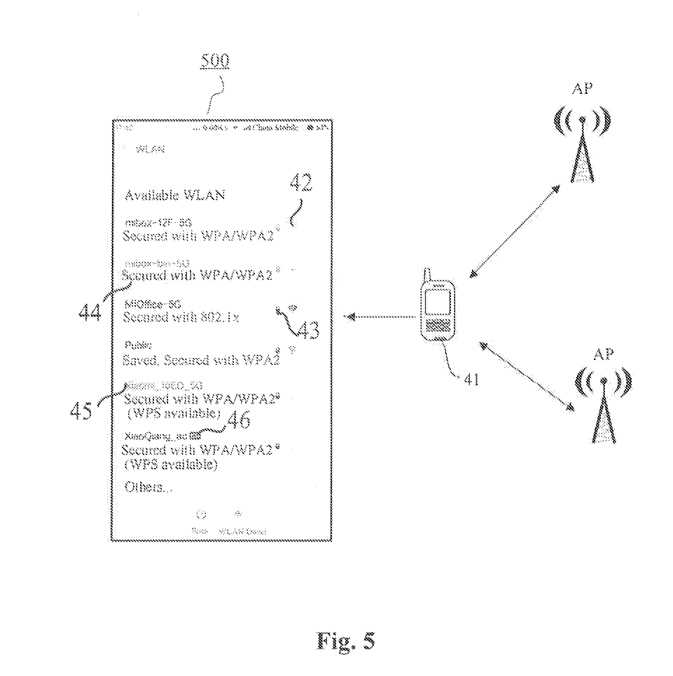

FIG. 5 is a schematic diagram of an interface 500 for displaying a wireless device list, according to an exemplary embodiment. Referring to FIG. 5, after acquiring surrounding signals, a mobile phone 41 displays on the interface 500 a wireless device list including a plurality of wireless access points, e.g., a WLAN list including a plurality of wireless routers, and relevant information regarding these wireless routers, such as a signal intensity indicator 42, an indicator 43 indicating whether a wireless router is encrypted, relevant description 44 about an encryption mode, and a wireless router name 45. Displayed information further includes an identity 46 of a manufacturer of a wireless router, the identity of the manufacturer being configured to indicate the manufacturer of the wireless router, i.e., which manufactures the wireless router. In the illustrated embodiment, the identity 46 of the manufacturer of the wireless router is displayed next to a name of the wireless router in the wireless device list.

In some embodiments, the second field in the broadcast information sent by a wireless router may be empty. In this case, after acquiring the broadcast information, the mobile phone will not display an identity of the manufacturer of the wireless router. For example, the mobile phone may only display a name and a signal intensity of the wireless router, and other device information.

In exemplary embodiments, the user may view the wireless device list, and determine to choose which wireless router for the mobile phone to connect according to information such as the above-mentioned encryption mode, signal intensity, and/or identity of the manufacturer. For example, two or more wireless routers may have similar signal intensities and similar encryption modes. In this case, without displaying an identity of the manufacturer of any of those wireless routers, the user may be unable to quickly determine which wireless router to access. However, based on one or more displayed device identities of one or more wireless routers, the user may select a router of a trusted manufacturer for access. For example, the user may select the wireless router named Xiaoqiang_ac in the WLAN list (FIG. 5) to access a wireless network, according to the displayed Xiaomi identity 46.

In other embodiments, if the wireless device is a Bluetooth device, the identity of the manufacturer of the Bluetooth device is displayed. For example, if the Bluetooth device is a Xiaomi mobile phone, the Xiaomi identity is displayed.

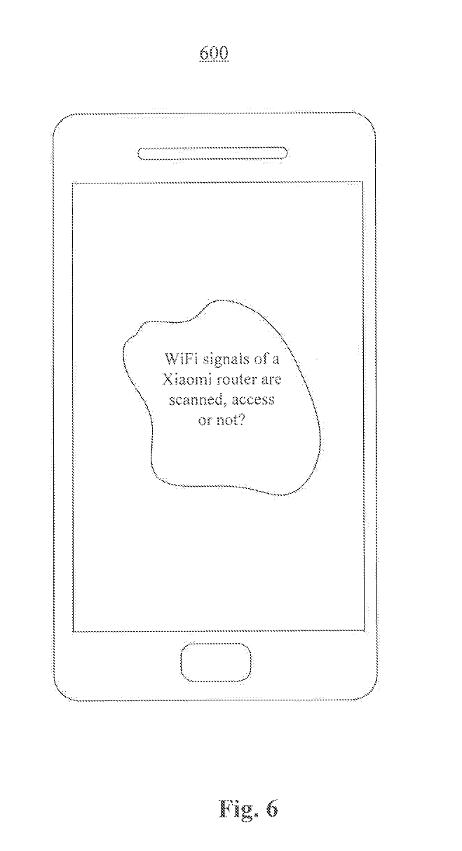

In another embodiment, an identity of a manufacturer may be preset with respect to a specific wireless device. For example, it may be set that only when a WiFi signal is acquired from a Xiaomi wireless router, access prompting information is popped up to prompt the user. FIG. 6 is a schematic diagram of an interface 600 for prompting the user whether to access a Xiaomi wireless router, according to an exemplary embodiment, in the illustrated embodiment, Xiaomi_Router is a preset identity and, when the preset identity is acquired, the identity is displayed through prompting information on the interface 600, for prompting the user to access the Xiaomi wireless router.

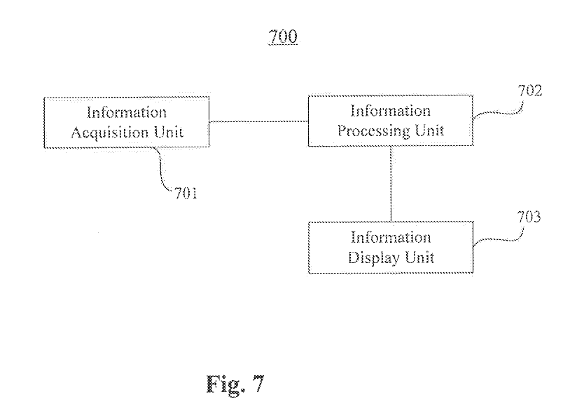

FIG. 7 is a block diagram of a device 700 for displaying a wireless device list, according to an exemplary embodiment. For example, the device 700 may be a mobile phone. Referring to FIG. 7, the device 700 includes an information acquisition unit 701, an information processing unit 702, and an information display unit 703.

The information acquisition unit 701 is configured to acquire broadcast information sent by a wireless device, the broadcast information including a first field for indicating a name of the wireless device and a second field for indicating a manufacturer of the wireless device.

The information processing unit 702 is configured to acquire an identity of the manufacturer of the wireless device according to the second field in the broadcast information.

The information display unit 703 is configured to display the name of the wireless device and the identity of the manufacturer in a wireless device list.

For example, the wireless device list, includes one or more wireless routers or one or more Bluetooth devices.

In one exemplary embodiment, the information processing unit 702 is configured to look up a corresponding relation between field information in the second field and the identity of the manufacturer stored in advance, according to the field information in the second field, to obtain the identity of the manufacturer corresponding to the field information.

In exemplary embodiments, the identity of the manufacturer may be a text identity of the manufacturer or an icon identity of the manufacturer.

In exemplary embodiments, the information display unit 703 is configured to display the identity of the manufacturer next to the name of the wireless device in the wireless device list.

In exemplary embodiments, the information acquisition unit 701 is also configured to acquire the broadcast information sent by the wireless device, the second field included in the broadcast information being empty, and the information display unit 703 is also configured to display the name of the wireless device in the wireless device list when the second field acquired by the information acquisition unit 701 is empty.

In exemplary embodiments, the broadcast information includes at least one of a MAC address, a frequency band, a signal intensity, or an encryption mode of the wireless device.

In exemplary embodiments, the information display unit 703 is configured to display the signal intensity of the wireless device in the wireless device list.

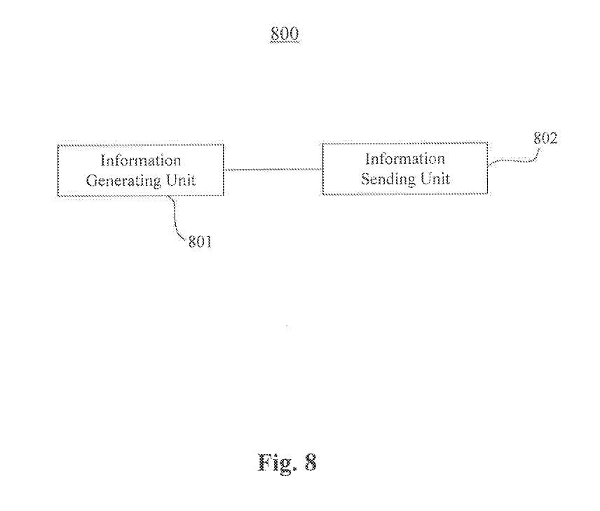

FIG. 8 is a block diagram of a wireless device 800, according to an exemplary embodiment. For example, the wireless device 800 may be a wireless router. Referring to FIG. 8, the device 800 includes an information generating unit 801 and an information sending unit 802.

The information generating unit 801 is configured to generate a second field configured to indicate a manufacturer of the wireless device 800.

The information sending unit 802 is configured to add the second field in broadcast information and send the broadcast information, the sent broadcast information including a first field configured to indicate a name of the wireless device and the second field.

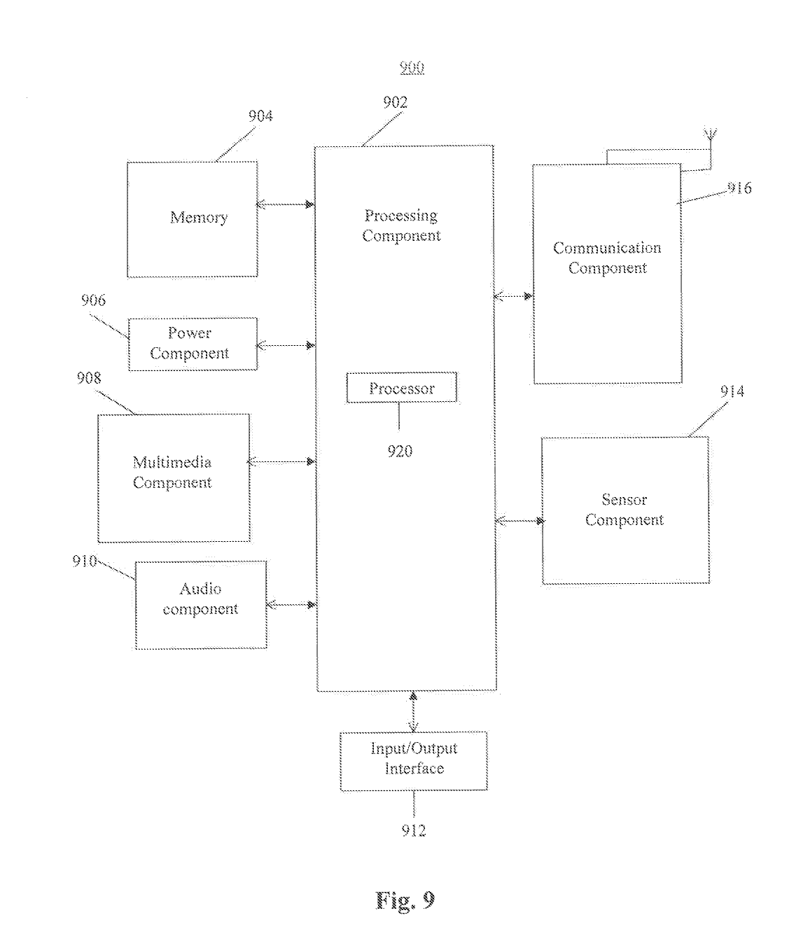

FIG. 9 is a block diagram of a terminal 900, according to an exemplary embodiment. For example, the terminal 900 may be a mobile phone, a computer, a digital broadcast terminal, a messaging device, a gaming console, a tablet, a medical device, exercise equipment, a personal digital assistant, and the like.

Referring to FIG. 9, the terminal 900 may include one or more of the following components: a processing component 902, a memory 904, a power component 906, a multimedia component 908, an audio component 910, an input/output (I/O) interface 912, a sensor component 914, and a communication component 916.

The processing component 902 typically controls overall operations of the terminal 900, such as the operations associated with display, telephone calls, data communications, camera operations, and recording operations. The processing component 902 may include one or more processors 920 to execute instructions to perform all or part of the steps in the above described methods. For example, the processor 920 is configured to: acquire broadcast information sent by a wireless device, the broadcast information including a first field configured to indicate a name of the wireless device and a second field configured to indicate a manufacturer of the wireless device; acquire an identity of the manufacturer of the wireless device according to the second field; and display the name of the wireless device and the identity of the manufacturer in a wireless device list. Moreover, the processing component 902 may include one or more modules which facilitate the interaction between the processing component 902 and other components. For instance, the processing component 902 may include a multimedia module to facilitate the interaction between the multimedia component 908 and the processing component 902.

The memory 904 is configured to store various types of data to support the operation of the terminal 900. Examples of such data include instructions for any applications or methods operated on the terminal 900, contact data, phonebook data, messages, pictures, video, etc. The memory 904 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 906 provides power to various components of the terminal 900. The power component 906 may include a power management system, one or more power sources, and any other components associated with the generation, management, and distribution of power in the terminal 900.

The multimedia component 908 includes a screen providing an output interface between the terminal 900 and a user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 908 includes a front camera and/or a rear camera. The front camera and/or the rear camera may receive an external multimedia datum while the terminal 900 is in an operation mode, such as a photographing mode or a video mode. Each of the front camera and the rear camera may be a fixed optical lens system or have focus and optical zoom capability.

The audio component 910 is configured to output and/or input audio signals. For example, the audio component 910 includes a microphone configured to receive an external audio signal when the terminal 900 is in an operation mode, such as a call mode, a recording mode, and a voice recognition mode. The received audio signal may be further stored in the memory 904 or transmitted via the communication component 916. In some embodiments, the audio component 910 further includes a speaker to output audio signals.

The I/O interface 912 provides an interface between the processing component 902 and peripheral interface modules, such as a keyboard, a click wheel, buttons, and the like. The buttons may include, but are not limited to, a home button, a volume button, a starting button, and a locking button.

The sensor component 914 includes one or more sensors to provide status assessments of various aspects of the terminal 900. For instance, the sensor component 914 may detect, an open/closed status of the terminal 900, relative positioning of components, e.g., the display and the keypad, of the terminal 900, a change in position of the terminal 900 or a component of the terminal 900, a presence or absence of user contact with the terminal 900, an orientation or an acceleration/deceleration of the terminal 900, and a change in temperature of the terminal 900. The sensor component 914 may include a proximity sensor configured to detect the presence of nearby objects without any physical contact. The sensor component 914 may also include a light sensor, such as a CMOS or CCD image sensor, for use in imaging applications. In some embodiments, the sensor component 914 may also include an accelerometer sensor, a gyroscope sensor, a magnetic sensor, a pressure sensor, or a temperature sensor.

The communication component 916 is configured to facilitate communication, wired or wirelessly, between the terminal 900 and other devices. The terminal 900 can access a wireless network based on a communication standard, such as WiFi, 2G, or 3G, or a combination thereof. In one exemplary embodiment, the communication component 916 receives a broadcast signal or broadcast associated information from an external broadcast management system via a broadcast channel. In one exemplary embodiment, the communication component 916 further includes a near field communication (NFC) module to facilitate short-range communications. For example, the NBC module may be implemented based on a radio frequency identification (RFID) technology, an infrared data association (IrDA) technology, an ultra-wideband (UWB) technology, a Bluetooth (BT) technology, and other technologies.

In exemplary embodiments, the terminal 900 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 904, executable by the processor 920 in the terminal 900, for performing the above-described methods. For example, the non transitory computer-readable storage medium may be a ROM, a RAM, a CD-ROM, a magnetic tape, a floppy disc, an optical data storage device, and the like.

In exemplary embodiments, there is also provided a wireless device including a processor and a memory for storing instructions executable by the processor. The processor is configured to generate a second field for indicating a manufacturer of the wireless device; and add the second field in broadcast information and send the broadcast information, the sent broadcast information including a first field for indicating a name of the wireless device and the second field.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the thereof. It is intended that the scope of the invention should only be limited by the appended claims.

What is claimed is:

1. A method for displaying a wireless device list, comprising:
acquiring broadcast information sent from a wireless device, the broadcast information including a first field for indicating a name of the wireless device and a second field for indicating a manufacturer of the wireless device;
acquiring an identity of the manufacturer of the wireless device according to the second field; and
displaying the name of the wireless device and the identity of the manufacturer in a wireless device list.

2. The method according to claim 1, wherein the acquiring of the identity of the manufacturer of the wireless device according to the second field comprises:
looking up a pre-stored corresponding relationship between field information in the second field and an identity of each of one or more manufacturers according to the field information, to acquire the identity of the manufacturer of the wireless device.

3. The method according to claim 1, wherein the acquiring of the identity of the manufacturer comprises:
acquiring one of a text identity of the manufacturer or an icon identity of the manufacturer.

4. The method according to claim 1, wherein the displaying comprises:
displaying the identity of the manufacturer next to the name of the wireless device in the wireless device list.

5. The method according to claim 1, further comprising:
determining that the second field in the broadcast information includes no field information; and
displaying the name of the wireless device without displaying the identity of the manufacturer in the wireless device list.

6. The method according to claim 1, wherein the displaying comprises:
popping up device prompting information regarding only the wireless device; and
displaying the name of the wireless device and the identity of the manufacturer in the device prompting information.

7. The method according to claim 1, wherein the acquiring of the broadcast information further comprises:
acquiring at least one of a media access control (MAC) address, a frequency band, a signal intensity, or an encryption mode of the wireless device.

8. The method according to claim 1, further comprising:
displaying a signal intensity of the wireless device in the wireless device list.

9. A method for a wireless device to send broadcast information, comprising:
generating a second field for indicating a manufacturer of the wireless device; and
adding the second field into broadcast information and sending the broadcast information, the sent broadcast information including a first field for indicating a name of the wireless device and the second field.

10. A terminal, comprising:
a processor; and
a memory for storing instructions executable by the processor;
wherein the processor is configured to:
acquire broadcast information sent by a wireless device, the broadcast information including a first field for indicating a name of the wireless device and a second field for indicating a manufacturer of the wireless device;
acquire an identity of the manufacturer of the wireless device according to the second field; and
display the name of the wireless device and the identity of the manufacturer in a wireless device list.

11. The terminal according to claim 10, wherein the processor is further configured to:
look up a pre-stored corresponding relationship between field information the second field and an identity of each of one or more manufacturers according to the field information, to acquire the identity of the manufacturer of the wireless device.

12. The terminal according to claim 10, wherein the processor is further configured to:
acquire one of a text identity of the manufacturer or an icon identity of the manufacturer.

13. The terminal according to claim 10, wherein the processor is further configured to:
display the identity of the manufacturer next to the name of the wireless device in the wireless device list.

14. The terminal according to claim 10, wherein the processor is further configured to:
determine that the second field in the broadcast information includes no field information; and
display the name of the wireless device without displaying the identity of the manufacturer in the wireless device list.

15. The terminal according to claim 10, wherein the processor is further configured to:
acquire at least one of a media access control (MAC) address, a frequency band, a signal intensity, or an encryption mode of the wireless device.

16. The terminal according to claim 10, wherein the processor is further configured to display a signal intensity of the wireless device in the wireless device list.

17. A wireless device, comprising:
a processor; and
a memory for storing instructions executable by the processor;
wherein the processor is configured to:
generate a second field for indicating a manufacturer of the wireless device; and
add the second field into broadcast information and send the broadcast information, the sent broadcast information including a first field for indicating a name of the wireless device and the second field.
